(19) United States
(12) Patent Application Publication
(10) Pub. No.: US 2009/0272694 A1
(43) Pub. Date: Nov. 5, 2009

(54) APPARATUS AND METHOD FOR SEPARATION MAGNETIC PARTICLES FROM A SOLUTION

(75) Inventor: Steven T. Krueger, Deerfield, WI (US)

Correspondence Address: FITZPATRICK CELLA HARPER & SCINTO, 30 ROCKEFELLER PLAZA, NEW YORK, NY, 10112, US

(73) Assignee: PROMEGA CORPORATION, Madison, WI (US)

(21) Appl. No.: 12/501,676

(22) Filed: Jul. 13, 2009

Related U.S. Application Data
(62) Division of application No. 11/867,226, filed on Oct. 4, 2007.
(60) Provisional application No. 60/849,795, filed on Oct. 6, 2006.

(51) Int. Cl. B03C 1/02

(52) U.S. Cl. 210/695

(57) ABSTRACT

A biological sample processing apparatus and method of use thereof. The biological sample processing apparatus includes a rod-shaped magnet having a north pole, a south pole, a length and a width, and a plunger covering the magnet. The north pole and the south pole of the rod-shaped magnet are substantially orthogonal to the length of the rod-shaped magnet. The apparatus separates magnetic particles from a solution containing, for example, a biological sample.

This application claims the benefit of U.S. Provisional Patent Application No. 60/849,795, filed Oct. 6, 2006.

### FIELD OF THE INVENTION

This invention relates to a method and an apparatus for separating magnetic particles from a solution containing a biological sample. Specifically, the invention relates to a biological sample processing apparatus that includes a rod-shaped magnet having a north pole, a south pole, a length and a width, and a plunger covering the magnet. The north pole and the south pole of the magnet are substantially orthogonal to the length of the magnet. The apparatus separates magnetic particles from a solution containing, for example, a biological sample. With this invention, a target biological material associated with magnetic particles can be separated from non-target biological material more efficiently than with conventional apparatuses and methods, particularly in low volume applications.

### BACKGROUND OF THE INVENTION

The use of magnets and magnetic particles for separating a target biological material from a non-target biological material is known. In conventional systems, magnetic particles are introduced into a solution containing biological material. The magnetic particles are complexed or associated with either a target biological material or a non-target biological material, depending on the application. When the magnetic particles are complexed with a target biological material, various processing steps are usually performed in a predetermined sequence. Typically, a cartridge containing a plurality of wells is used to facilitate each of the processing steps. The steps may include an clution step, a washing step, a cell lysis step, or the like. The individual wells generally contain solutions or components necessary for a particular step. For example, when cell lysis is to be performed, the particular well will contain a lysis reagent. In this manner, the target biological material (e.g., DNA, RNA, proteins, etc.) can be processed to a desired state.

To facilitate the separation of the magnetic particle-biological material complex from the remaining solution, various methods and apparatuses have been designed. U.S. Pat. Nos. 6,207,463 and 6,448,092, for example, are each directed to a device and a method for separating microparticles involving a magnetic rod. Rods of this type may be used either alone or in combination with an apparatus designed to automate biological sample processing. Examples of these machines include the Freedom EVO® manufactured by Tecan Trading AG of Switzerland, the Biomek® 2000 Laboratory Automation Workstation, manufactured by Beckman Coulter of Fullerton, Calif., and the Eppendorf® epMotion™, manufactured by Eppendorf of Germany, which have relatively high throughput capability. Others, such as the Maxwell™ 16 sold by Promega Corporation of Madison, Wis., have lower throughputs.

In both the '463 and '092 patents, the poles of the magnet are substantially parallel to the length of the magnet. When the magnetic rod is placed in the biological solution, the position of the upper pole of the magnet prevents the pole from serving as a strong point of attraction for the magnetic particles in the solution. That is, because the upper pole of the magnet is directed toward a portion of the rod, rather than the solution containing the magnetic particles, the magnetic particles are not strongly attracted to the upper pole. Indeed, both the '463 and the '092 patents describe that the magnet is long enough to ensure that the upper pole of the magnet remains above the level of the solution containing the magnetic particles, preventing any particles from binding to that portion of the magnet. This orientation, therefore, effectively decreases the power of the magnet. In addition, the vertical orientation of the magnet results in magnetic particles being attracted to the entire length of the magnet. The large surface area of the magnet to which the magnetic particles are attracted can make the magnetic rod difficult to use in low volume applications, and particularly in low volume elutions.

This invention is directed to remedying the problems of conventional magnetic particle separation apparatuses. In particular, the present invention uses a magnet in which the poles of the magnet are substantially orthogonal to the length of the magnet. With such an orientation, both poles of the magnet may be used for attracting magnetic particles. Additionally, by controlling the diameter-to-length ratio of the magnet, the lines of magnetic force can be oriented so that the magnetic particles are concentrated at the tip of the rod and magnet. By concentrating the particles near the tip, the volume of solution that is carried over from one well to another (the carry-over liquid) is decreased, and the volume of solution that is needed to elute the particles also decreases. In this regard, the apparatus and method of this invention can be used in low volume applications with greater ease and efficiency than with conventional apparatuses and methods.

### SUMMARY OF THE INVENTION

In one aspect, the present invention is directed to a biological sample processing apparatus having a rod-shaped magnet having a north pole, a south pole, a length, and a width. A plunger covers the rod-shaped magnet. The north pole and the south pole of the rod-shaped magnet are substantially orthogonal to the length of the rod-shaped magnet.

The biological sample processing apparatus may also include a non-magnetic plunger rod having an upper portion, a lower portion, and a length. The rod-shaped magnet is attached to the non-magnetic rod, and the plunger covers the rod-shaped magnet and at least a portion of the length of the non-magnetic plunger rod.

The lower portion of the non-magnetic rod may define a cavity into which the rod-shaped magnet is attached. When the rod-shaped magnet is fixed in the cavity, the north pole and the south pole of the rod-shaped magnet are substantially orthogonal to the length of the non-magnetic plunger rod.

The non-magnetic rod may be made of non-ferrous stainless steel, brass, aluminum, nickel alloy, or a graphite composite, but preferably non-ferrous stainless steel. The magnet may be cylindrical in shape and the diameter-to-length ratio of the magnet is preferably 1:1.5.

The plunger is preferably made of polypropylene, polyethylene, or polytetrafluoroethylene, and more preferably, polypropylene.

In another aspect, the present invention is directed to a method of separating magnetic particles from a solution. The method includes a step of inserting a magnetic apparatus into a solution containing magnetic particles and a step of removing the magnetic apparatus and the magnetic particles from the solution. The magnetic apparatus includes a rod-shaped magnet having a north pole, a south pole, a length and a width, and a plunger covering the rod-shaped magnet. The north pole and the south pole of the rod-shaped magnet are substantially orthogonal to the length of the rod-shaped magnet.

These and other aspects of the present invention will be apparent upon consideration of the following detailed description taken in conjunction with the accompanying drawings, in which preferred embodiments of the present invention are described and illustrated.

### DESCRIPTION OF THE DRAWINGS

FIG. 1 depicts the lower portion of a non-magnetic plunger rod.

FIG. 2 depicts the lower portion of a non-magnetic plunger rod having a cavity formed therein.

FIG. 3 depicts a magnetic apparatus including a plunger covering the non-magnetic plunger rod having a rod-shaped magnet placed in a cavity formed in the lower portion of the non-magnetic plunger rod.

FIG. 4 depicts a container holding a solution containing magnetic particles.

FIG. 5 depicts the magnetic apparatus being inserted into a container holding a solution containing magnetic particles.

FIG. 6 depicts the magnetic apparatus along with magnetic particles being removed from the solution depicted in FIG. 5.

Throughout the figures, like or corresponding reference numerals denote like or corresponding parts.

### DETAILED DESCRIPTION OF THE PRESENT INVENTION

The present invention relates to a biological sample processing apparatus including a rod-shaped magnet having a north pole, a south pole, a length and a width, and a plunger covering the rod-shaped magnet. The north pole and the south pole of the rod-shaped magnet are substantially orthogonal to the length of the rod-shaped magnet. The operator of the apparatus may place the apparatus in a container containing magnetic particles. In order to perform biological sample processing, the magnetic particles are attached to, complexed with, or otherwise associated with a target or a non-target biological material (e.g., DNA, RNA, proteins, etc.), depending on the desired application. When the biological sample processing apparatus is placed in the container, the magnetic particles are attracted to the magnet and adhere to the outer surface of the plunger. When the operator removes the biological sample processing apparatus from the container, the magnetic particles are removed along with the apparatus. In this manner, the magnetic particles associated with the target or non-target biological material are removed from the solution.

The biological sample processing apparatus of this invention is particularly advantageous for low volume applications in which sequential processing steps are required of a target biological material. For example, the apparatus of the present invention is advantageously used in automated systems such as the Maxwell™ 16 sold by Promega Corporation of Madison, Wis. As discussed above, in many biological processing methods, a target biological material is first removed from a sample containing a plurality of biological materials. The target material is then further processed by, for example, washing the target biological material, lysing the target biological material, and eluting the target biological material. Typically, when sequentially processing the target biological material using an apparatus such as the Maxwell™ 16, a cartridge of wells is used. Each well contains the solutions and reagents needed for a particular step in the processing method, and the target biological material is sequentially inserted into and removed from each well. As the target biological material is removed from each well, a portion of the liquid in the well is removed along with the target biological material. This carry-over liquid can hamper the subsequent step in the processing sequence, and the amount of the carry-over liquid is to be minimized, especially in low volume applications. Additionally, in low volume applications, to ensure maximum yield and efficiency, it is important that the maximum amount of target material be processed and that the target material be contained in the smallest amount of space possible. The present invention has been designed with these requirements in mind.

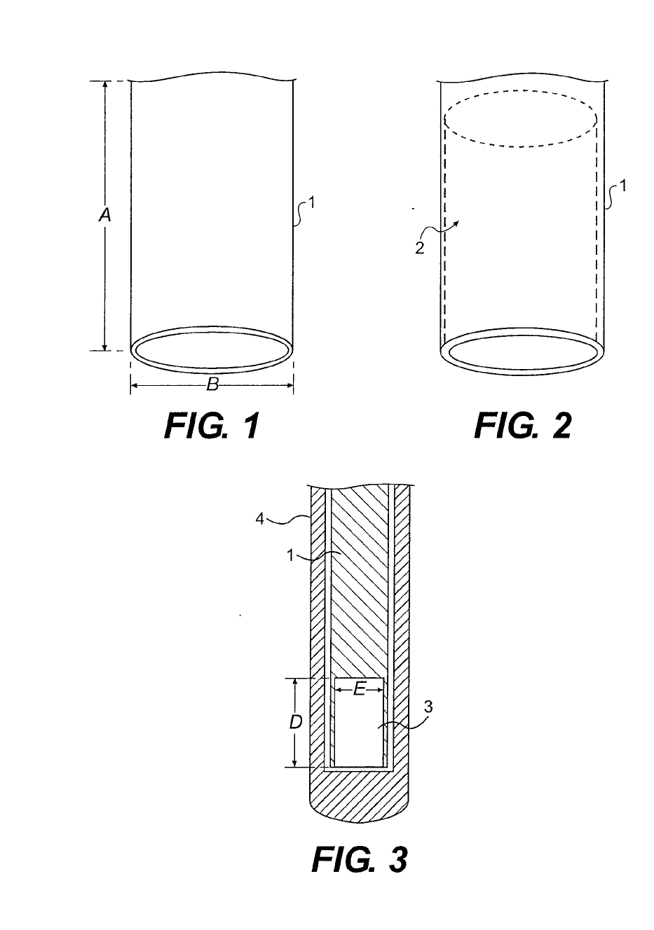

FIG. 1 depicts a lower portion of a non-magnetic plunger rod 1, according to one aspect of the present invention. The non-magnetic plunger rod preferably has a cylindrical shape, but the invention is not so limited. As depicted in FIG. 1, the non-magnetic plunger rod has a length A and a diameter B. The non-magnetic material for the plunger rod is not particularly limited; however, non-ferrous stainless steel, brass, aluminum, nickel alloys, and graphite composites are preferred, with non-ferrous stainless steel being the most preferred.

FIG. 2 depicts the non-magnetic plunger rod 1 depicted in FIG. 1 after a portion of the lower portion of the non-magnetic plunger rod 1 has been removed to form a cavity 2. In the embodiment depicted in FIG. 2, the cavity has a cylindrical shape, but the invention is not so limited. Other shapes, e.g., a rectangular shape, may be used without departing from the scope of the present invention. Into the cavity, a magnet 3 (shown in FIG. 3) may be placed. The magnet may be press-fitted, glued, or otherwise attached to the non-magnetic plunger rod. It should be noted that the present invention is not limited to the embodiments depicted in FIGS. 1 and 2. For example, the present invention may be used without a non-magnetic plunger rod at all, or, if a non-magnetic plunger rod is used, the magnet may be attached to the non-magnetic plunger rod by glue or other attachment means. That is, a cavity need not be formed in a portion of the lower portion of the plunger rod. Additionally, the non-magnetic plunger rod may be either solid or tubular.

The shape and size of the magnet according to the present invention are not particularly limited. As discussed below, the magnet is preferably rod-shaped and has a width-to-length ratio of approximately 1:1.5, although other ratios (e.g., 1:1) may be used. In the embodiment depicted in FIG. 3, the magnet has a cylindrical shape, although other shapes, such as cubic, may be used.

FIG. 3 depicts an embodiment of the present invention in which the magnet 3 has been placed in a cavity of the lower portion of the non-magnetic plunger rod 1. As can be seen in FIG. 3, the magnet has a length D and a width (diameter) E. The north and south poles of the magnet are oriented so that the poles are substantially orthogonal to the length of the magnet D. In FIG. 3, the poles of the magnet 3 are oriented in the horizontal plane. The position of the poles in the horizontal plane is not particularly important. For example, when viewing FIG. 3, the poles may be oriented left to right or front to back, or anywhere in between. What is important is that the poles of the magnet be substantially orthogonal to the length of the magnet. With such an orientation of both poles, the strongest magnetic regions of the magnet may be used in attracting magnetic particles during biological processing.

As shown in FIG. 3, a plunger 4 covers the lower portion of the non-magnetic plunger rod 1 and the magnet 3. The material for the plunger is not particularly limited; however, chemically inert, disposable materials that do not alter the magnetic field are preferred. Examples of such materials include polypropylene, polyethylene, and polytetrafluoroethylene (PTFE). Of these materials, polypropylene is most preferred. The shape of the plunger 4 is also not particularly limited. In systems in which a standard elution tube is to be used, the plunger 4 preferably has the shape depicted in FIG. 3. That is, it is preferred for the plunger 4 to have a generally cylindrical shape that tapers into a cone at the bottom. The end of the cone is preferably rounded. In this regard, the bottom of the plunger 4 corresponds to the conical bottom of the standard elution tube.

When using the plunger 4 depicted in FIG. 3, it is preferred for the magnet 3 to have a width-to-length ratio of approximately 1:1.5. This ratio allows for the magnetic particles of the solution to adhere tightly to the plunger 4 without the particles being spread out so far that it would be difficult to cover them completely during elution. If the magnetic particles in the solution are very dilute, then a lower ratio, for example, 1:1, might be preferred, especially if an even lower elution volume is needed. Additionally, if the angle of the cone of a standard elution tube were to increase, the lower ratio would be needed in order to elute in the same volume. The particles, however, would be further from the magnet.

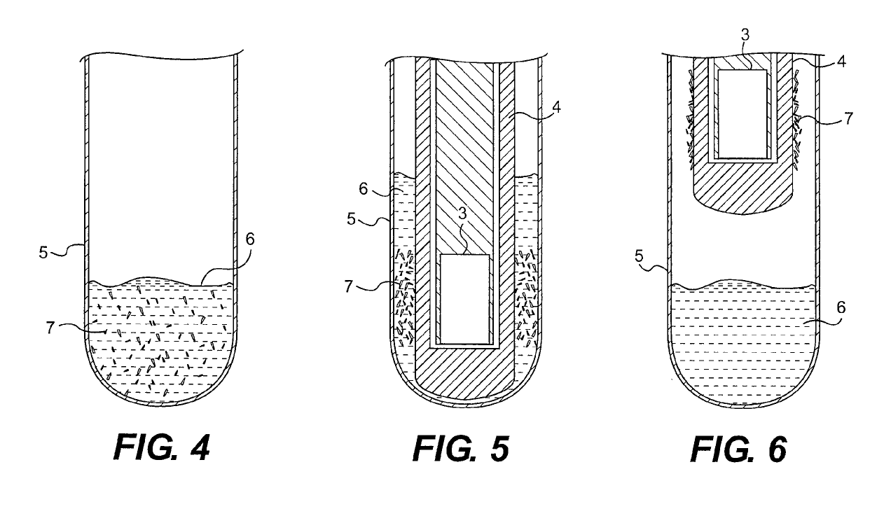

FIGS. 4-6 depict the steps of the use of the apparatus of the present invention depicted in FIG. 3 for biological sample processing. FIG. 4 depicts a container 5 holding a solution 6 containing magnetic particles 7. The magnetic particles 7 are attached to, complexed with, or otherwise associated with a target or non-target biological material present in the solution 6, depending on the desired application. In FIG. 5, the apparatus of FIG. 3 is inserted into the solution 6. As can be seen in FIG. 5, the magnetic particles 7 migrate toward the poles of the magnet 3, which, for purposes of the discussion of FIGS. 5 and 6, are oriented left to right. In FIG. 6, the apparatus is removed from the container 5. The magnetic particles adhere to the surface of the plunger 4 and are also removed from the solution 6. If further processing of the biological material associated with the magnetic particles 7 is needed, the particles may be transferred to another container or well.

The lines of magnetic force associated with the orientation of the poles and the width-to-length ratio of the magnet 3 force the magnetic particles 7 to adhere to the lower portion of the plunger 4. As noted above, this configuration allows the magnetic particles 7 to tightly adhere to the surface of the plunger 4 over a minimum of space. This is particularly important and advantageous in low volume applications. By having the poles of the magnet substantially orthogonal to the length of the magnet, the width or diameter of the magnet may be further decreased, if necessary, without also decreasing the power of the magnet. The configuration of the present invention also allows for the use of plungers having thinner walls than conventional plungers, which is beneficial when the plungers are manufactured by injection molding.

While the present invention has been described with reference to explanatory embodiments, it is to be understood that the terms used herein are terms of description rather than limitation. Various changes and modifications may be made without departing from the scope and spirit of the present invention as set forth in the claims.

1-7. (canceled)

8. A method for separating magnetic particles from a solution, the method comprising:
a step of inserting a magnetic apparatus into a solution containing magnetic particles; and
a step of removing the magnetic apparatus and the magnetic particles from the solution,
wherein the magnetic apparatus comprises:
(i) a rod-shaped magnet having a north pole, a south pole, a length, and a width; and
(ii) a plunger covering the magnet,
wherein the north pole and the south pole of the rod-shaped magnet are substantially orthogonal to the length of the rod-shaped magnet.

9. The method according to claim 8, wherein the magnetic apparatus further comprises a non-magnetic plunger rod having an upper portion, a lower portion, and a length,
wherein the rod-shaped magnet is attached to the non-magnetic rod, and the plunger covers the rod-shaped magnet and at least a portion of the length of the non-magnetic plunger rod.

10. The method according to claim 8, wherein the rod-shaped magnet has a width-to-length ratio of approximately 1:1.5.

11. The method according to claim 8, wherein the lower portion of the non-magnetic plunger rod defines a cavity into which the rod-shaped magnet is attached.

12. The method according to claim 11, wherein when the ro-shaped magnet is fixed in the cavity of the non-magnetic plunger rod, the north pole and the south pole of the rod-shaped magnet are substantially orthogonal to the length of the non-magnetic plunger rod.

13. The method according to claim 9, wherein the non-magnetic plunger rod comprises non-ferrous stainless steel.

14. The method according to claim 8, wherein the plunger comprises polypropylene.
